(19) United States
(12) Patent Application Publication
(10) Pub. No.: US 2026/0078774 A1
(43) Pub. Date: Mar. 19, 2026

(54) ELECTRONICALLY COMMUTATED MOTOR AND MODULAR ASSEMBLY HAVING SAID ELECTRONICALLY COMMUTATED MOTOR

(71) Applicant: BÜHLER MOTOR GMBH, Nürnberg (DE)

(72) Inventors: Klaus Weiske, Altdorf (DE); Jürgen Leykamm, Kirchensittenbach (DE); Daniel Bierl, Schnaittach (DE); Norbert Chemnitz, Nürnberg (DE); Eduard Ene, Nürnberg (DE); Alexander Reul, Frensdorf-OT Reundorf (DE); Katherine Bee, Nürnberg (DE); Paul-Peter Golditz, Nürnberg (DE); Christoph Tysack, Rüting (DE); Sebastian Ortega Salinas, Nürnberg (DE)

(73) Assignee: BÜHLER MOTOR GMBH, Nürnberg (DE)

(21) Appl. No.: 19/396,778

(22) Filed: Nov. 21, 2025

Related U.S. Application Data
(63) Continuation of application No. PCT/EP2024/063300, filed on May 15, 2024.

(30) Foreign Application Priority Data
May 23, 2023 (DE) 10 2023 113 462.0

(51) Int. Cl. F04D 29/58; F04D 13/06; F04D 13/14; H02K 5/18; H02K 5/22; H02K 9/22; H02K 11/33; H02K 21/16

(52) U.S. Cl. CPC F04D 29/5806; F04D 13/06; F04D 13/14; H02K 5/18; H02K 5/225; H02K 9/227; H02K 11/33; H02K 21/16; H02K 2211/03

(57) ABSTRACT

The invention relates to an electronically commutated motor, comprising a permanent magnet rotor supported on a motor shaft, a stator lamination stack, at least one insulating cap arranged on an axial end face of the stator lamination stack, a winding that runs across all coils of the stator lamination stack and is contacted by means of insulation-displacement contacts.

### CROSS-REFERENCE TO RELATED APPLICATIONS

This present patent application is a continuation application of PCT Application No. PCT/EP2024/063300 filed on May 15, 2024, which is based on German Application No. DE 10 2023 113 462.0 filed on May 23, 2023, all of which are incorporated by reference in their entirety.

### BACKGROUND OF THE INVENTION

### Field of the Invention

The invention relates to an electronically commutated motor and to a modular assembly for forming different fluid pumps with different power ratings, as well as to a modular assembly for forming different electric drives with different power ratings.

### Description of Related Art Including Information Disclosed Under 37 CFR 1.97 and 1.98

In known generic electronically commutated motors with integrated control electronics, heat is dissipated from the stator and electronic components on the printed circuit board (PCB) via the motor housing to the ambient air. If the known motor is used in a fluid pump, heat is additionally dissipated via a containment shell arranged between the rotor and the stator. The disadvantage of fluid pumps here is that the containment shell is an additional component and causes additional material costs. The main disadvantage of such known motors is poor heat dissipation via the housing to the ambient air.

The object of the invention is to propose an electronically commutated motor and a modular assembly for forming different fluid pumps with different power ratings as well as different electric drives with different power ratings with such electronically commutated motor, which ensures efficient heat dissipation from the electronic components and the stator, good lubrication and actuation, enables easy scaling of the motor for different power classes, ensures a compact and robust design of the motor, reduces the number of components and thus saves costs by using identical parts, as well as a flexible design of the mechanical, hydraulic and electrical application interfaces by identical parts. Another object is to ensure reliable media separation in the fluid pumps without dynamic seals during long operating times.

### BRIEF SUMMARY OF THE INVENTION

This object is achieved by an electronically commutated motor, comprising: a permanent magnet rotor mounted on a motor shaft; a stator lamination stack; at least one insulating cap arranged on an axial end face of the stator lamination stack; a winding that runs across all coils of the stator lamination stack and is contacted by means of insulation-displacement contacts, wherein the stator lamination stack, the at least one insulating cap and the winding form the stator and surround the permanent magnet rotor; the stator is completely surrounded on its outer region and at least partially on its inner region by an overmolding made of non-magnetic material, the overmolding forming a motor housing; at least one groove running parallel to the axis is formed in the inner region of the overmolding; at least two notches are formed on an axial end face of the overmolding, which are connected to one another via a radially circumferential channel; and a receiving space is formed in the motor housing, in which an electronics and a thermal plate are accommodated.

This object is achieved by a modular assembly for forming different fluid pumps with different power ratings as well as different electric drives with different power ratings with the electronically commutated motor, comprising a permanent magnet rotor mounted on a motor shaft, a stator lamination stack; at least one insulating cap arranged on an axial end face of the stator lamination stack, a winding that runs across all coils of the stator lamination stack and is contacted by means of insulation-displacement contacts, wherein: the stator lamination stack, the at least one insulating cap and the winding form the stator and surround the permanent magnet rotor; the stator is completely surrounded on its outer region and at least partially on its inner region by an overmolding made of non-magnetic material, the overmolding forming a motor housing; at least one groove running parallel to the axis is formed in the inner region of the overmolding; at least two notches are formed on an axial end face of the overmolding, which are connected to one another via a radially circumferential channel; and a receiving space is formed in the motor housing, in which an electronics and a thermal plate are accommodated, wherein the motor housing is closed on an axial end face by an intermediate plate to form a fluid pump, in particular a centrifugal pump, and wherein an impeller is pressed onto the motor shaft.

This object is achieved by a modular assembly for forming different fluid pumps with different power ratings as well as different electric drives with different power ratings with the electronically commutated motor, comprising a permanent magnet rotor mounted on a motor shaft, a stator lamination stack; at least one insulating cap arranged on an axial end face of the stator lamination stack, a winding that runs across all coils of the stator lamination stack and is contacted by means of insulation-displacement contacts, wherein: the stator lamination stack, the at least one insulating cap and the winding form the stator and surround the permanent magnet rotor; the stator is completely surrounded on its outer region and at least partially on its inner region by an overmolding made of non-magnetic material, the overmolding forming a motor housing; at least one groove running parallel to the axis is formed in the inner region of the overmolding; at least two notches are formed on an axial end face of the overmolding, which are connected to one another via a radially circumferential channel; and a receiving space is formed in the motor housing, in which an electronics and a thermal plate are accommodated, wherein the motor housing is closed on an axial end face by a pump head with at least one hydraulic interface in order to form a fluid pump, in particular an oil pump, and wherein a holder is arranged in the pump head, wherein the holder receives a pump rotor, which is formed by an inner rotor and an outer rotor, and is pressed onto the motor shaft and mounts the motor shaft in the holder.

This object is achieved by a modular assembly for forming different fluid pumps with different power ratings as well as different electric drives with different power ratings with the electronically commutated motor, comprising a permanent magnet rotor mounted on a motor shaft, a stator lamination stack; at least one insulating cap arranged on an axial end face of the stator lamination stack, a winding that runs across all coils of the stator lamination stack and is contacted by means of insulation-displacement contacts, wherein: the stator lamination stack, the at least one insulating cap and the winding form the stator and surround the permanent magnet rotor; the stator is completely surrounded on its outer region and at least partially on its inner region by an overmolding made of non-magnetic material, the overmolding forming a motor housing; at least one groove running parallel to the axis is formed in the inner region of the overmolding; at least two notches are formed on an axial end face of the overmolding, which are connected to one another via a radially circumferential channel; and a receiving space is formed in the motor housing, in which an electronics and a thermal plate are accommodated, wherein the motor housing is closed on an axial end face by an end shield to form an electric drive and wherein the motor shaft is mounted in the end shield.

The invention is based on the idea of providing an electronically commutated motor, comprising a permanent magnet rotor supported on a motor shaft, a stator lamination stack, at least one insulating cap arranged on an axial end face of the stator lamination stack, a winding that runs across all coils of the stator lamination stack and is contacted by means of insulation-displacement contacts, wherein: the stator lamination stack, the at least one insulating cap and the winding form the stator and surround the permanent magnet rotor; the stator is completely surrounded on its outer region and at least partially on its inner region by an overmolding made of non-magnetic material, the overmolding forming a motor housing; at least one groove running parallel to the axis is formed in the inner region of the overmolding; at least two notches are formed on an axial end face of the overmolding, which are connected to one another via a radially circumferential channel; and a receiving space is formed in the motor housing, in which an electronics and a thermal plate are accommodated.

The at least one insulating cap, preferably two insulating caps, can be plugged or mounted as prefabricated parts onto the axial end faces of the stator lamination stack. Alternatively, the at least one insulating cap can be molded onto the stator lamination stack using an injection molding process before the wound stator lamination stack is overmolded with non-magnetic material.

The overmolding is made of a non-magnetic material, i.e., a plastics material.

The winding running across all coils of the stator lamination stack can be formed by a continuous winding or by several winding wires and is contacted by means of insulation-displacement contacts. The insulation-displacement contacts are only partially encased by the overmolding and extend from the overmolding to a PCB where they are contacted. The insulation-displacement contacts can be configured as a single contact or multi-contact, such as a double bifilar contact. The advantage of using at least one double bifilar contact is that four wires are contacted simultaneously, which enables complex winding connections (e.g., delta semi-parallel) and a higher current transmission is possible because the current flow is divided into four paths. Alternatively, the winding can also be contacted using contact plates or other contacting means known to a person skilled in the art.

The connection can be realized by a star-parallel winding, star-series winding, delta-series winding, delta-parallel winding, delta-semi-parallel winding, delta-series connection, delta-double-parallel connection or a delta-quadruple-parallel connection.

At least one groove running parallel to the axis is formed in the inner region of the overmolding. This at least one groove serves to optimize the circulation and fluid transport to dissipate the heat from the stator into the fluid when using the electronically commutated motor in fluid pumps.

At least two notches are formed on an axial end face of the overmolding, which are connected to one another via a radially circumferential channel. Said notches are located in the axial direction above the wound coils of the stator lamination stack in the overmolding and correspond to the at least one groove in the inner region of the overmolding that runs parallel to the axis.

A receiving space is formed in the motor housing in which an electronics and a thermal plate are accommodated. The electronics comprises a populated PCB responsible for controlling the motor. It is advantageous if the PCB is populated with the electronics on both sides. Alternatively, the PCB can also be populated with the electronics on only one side. Pins for fastening the thermal plate to the motor housing and pins for fastening the PCB to the motor housing are formed in the receiving space of the motor housing.

In one development, the overmolding has at least one radial groove on the outer region for receiving a sealing element and/or has a receiving contour for a connector. A connector housing is attached to the receiving contour. The connector housing can be attached to the receiving contour in a materially bonded and form-fitting manner by means of ultrasonic welding or laser welding. The receiving contour has an eyeglass-shaped receptacle for different connector housings in its inner circumference, through which they can be passed, and at least one energy director or a circumferential elevation on its outer circumference, which is materially bonded to the connector housing during ultrasonic welding or laser welding and is thus circumferentially welded tightly to the overmolding. In addition, the receiving contour comprises at least one guide, preferably two, into which the connector housing can be mounted. The advantage of having at least one guide is that the connector housing can also absorb forces in the at least one guide when mounted. The receiving contour on the overmolding ensures lower complexity and better producibility of the connector housing attachment to the overmolding. This moreover allows for greater variability in different applications without having to adapt or change the tool during the injection molding process to produce the overmolding. Advantageously, the connector housing comprises at least one connector tab which is contacted with the PCB.

Alternatively, the connector housing can be plugged onto the receiving contour. In a further alternative, the connector housing can also be molded directly onto the overmolding without a receiving contour or can be formed on or attached to an electronics cover that closes the receiving space of the motor housing.

The overmolding can advantageously have recesses on the inner region, preferably between the grooves running parallel to the axis, such that the stator laminations of the stator lamination stack exposed within the recesses are surrounded by a fluid or air in the interior of the motor. Due to the recesses in the overmolding, the stator lamination stack is exposed in this region. This advantageously promotes the dissipation of heat from the stator. Alternatively, the overmolding can only have grooves in its inner region. This is desirable for applications in which the stator lamination stack is not supposed to be exposed. In an alternative embodiment, the overmolding can be configured as a slotted tube or have a base region on an axial end face; i.e., the overmolding can be configured as a containment shell.

In accordance with one development, the thermal plate provides a bearing receptacle on one side and has several cutouts on the other side for large electronic components arranged on a PCB. The thermal plate is provided between the overmolding and the electronics, wherein the thermal plate can comprise a bearing receptacle for a bearing. A sensor magnet can be attached to the motor shaft towards the thermal plate. When using a monolithic bearing, no bearing is required in the thermal plate. Large electronic components such as electrolytic capacitors can be accommodated in a space-saving manner in the cutouts of the thermal plate. The advantage is that the PCB can be populated with electronic components on both sides, wherein the smaller electronic components can be accommodated in a space-saving manner on the underside of the PCB. Additionally, the thermal plate has several screw eyes to which the PCB is attached. This allows some of the heat generated by the electronic components to be dissipated to the thermal plate. It is advantageous to additionally use thermal interface materials such as a thermal paste directly beneath the electronic components that generate heat, so that the heat is transferred to the thermal plate over a large area. It is conceivable to coat individual contacts or contact points on the PCB or the entire PCB with potting material, but also to coat only a single side of the PCB with potting material. The potting material can also be used additionally to seal the connector tabs in the connector. Another advantage of this is that not only the connector tabs in the connector, but also the contact points of the connector on the receiving contour of the overmolding are sealed by the potting material. The potting material can also be used to attach large electronic components to the thermal plate in order to advantageously “glue” them there and dampen potential vibrations. It is also conceivable to use the thermal paste, which is dosed between the thermal plate and the PCB, to fix the large electronic components to the thermal plate. Alternatively, the populated PCB can also be encapsulated with potting material. When encasing the PCB with potting material, it is advantageous that less potting material is required due to the overmolding. This leads to cost and material savings.

The PCB is advantageously adapted in terms of its dimensions to the size of the electronics cover and is attached to the overmolding or fixed in the receiving space of the overmolding. The electronics cover is flat and can have a pressure equalization element and a honeycomb structure that supports additional heat dissipation of the electronic components on the PCB. When mounting the electronics cover on the overmolding, the electronics cover is attached to the overmolding by laser welding, ultrasonic welding or hot gas welding. Alternatively, the electronics cover can also be screwed or glued onto the overmolding. The electronics cover and a connector can also be formed in one piece or as multiple parts, which connector is then attached to the overmolding.

The PCB and the several cutouts of the thermal plate can be filled with potting material. In that process, the PCB and the thermal plate are encased in potting material. The casing advantageously forms the electronics cover as an additional function. In such case, a separate electronics cover is no longer required, which in turn avoids additional components and additional costs.

The thermal plate is accommodated in at least one receiving contour on the inner region of the overmolding and seals the overmolding axially on one side. The thermal plate can serve as a separating element between a wet room and a dry room in fluid pumps and additionally as a heat dissipation element in fluid pumps or electric drives. Due to the at least one receiving contour on the inner region of the overmolding, the thermal plate can be accurately fitted into the overmolding and attached to the overmolding by laser welding. Alternatively, the thermal plate can be ultrasonically embossed with the overmolding across at least one pin, preferably three or four pins. At least one pin penetrates the thermal plate and is ultrasonically embossed therewith. It is also conceivable for the thermal plate to be hot-staked thereto using at least one pin. However, other methods of fastening the thermal plate to the overmolding known to a person skilled in the art, such as by screwing, are also conceivable. The method of fastening the thermal plate to the overmolding can result in a material bond. A force-fitting fastening of the thermal plate to the overmolding could be achieved, for example, by pressing it in. Alternatively, the thermal plate can be joined to the overmolding by means of thermal direct joining if the thermal plate is made of metallic material. The thermal plate can be made of a non-magnetic material, for example plastics material or a metallic material. The choice of material for the thermal plate depends on the power rating class of the electronically commutated motor. In a further alternative, the thermal plate can be overmolded with non-magnetic material in one method step together with the stator and can be configured as the base or containment shell base of the overmolding. This would eliminate the need for an additional method of fastening the thermal plate to the overmolding.

The invention is further based on the idea of providing a modular assembly for forming different fluid pumps with different power ratings as well as different electric drives with different power ratings with the electronically commutated motor, comprising a permanent magnet rotor supported on a motor shaft, a stator lamination stack, at least one insulating cap arranged on an axial end face of the stator lamination stack, a winding that runs across all coils of the stator lamination stack and is contacted by means of insulation-displacement contacts, wherein: the stator lamination stack, the at least one insulating cap and the winding form the stator and surround the permanent magnet rotor; the stator is completely surrounded on its outer region and at least partially on its inner region by an overmolding made of non-magnetic material, the overmolding forming a motor housing; at least one groove running parallel to the axis is formed in the inner region of the overmolding; at least two notches are formed on an axial end face of the overmolding, which are connected to one another via a radially circumferential channel; and a receiving space is formed in the motor housing, in which an electronics and a thermal plate are accommodated, wherein the motor housing is closed on an axial end face by an intermediate plate to form a centrifugal pump, and wherein an impeller is pressed onto the motor shaft.

The intermediate plate can be materially bonded to the motor housing, for example by laser welding. Alternatively, the intermediate plate can be connected to the motor housing in a force-fitting manner, for example by means of screws. It is also conceivable for the intermediate plate to be produced in one method step together with the overmolding. Several fluid openings are formed in the intermediate plate through which the fluid enters the interior of the motor.

In a preferred embodiment, a pump head with a suction inlet and a pressure outlet is fastened to the intermediate plate. The pump head can be materially bonded to the intermediate plate, for example by laser welding. Alternatively, the pump head can be connected to the intermediate plate in a force-fitting manner, for example by means of screws.

In one development, the motor shaft is supported in two bearing points, and a thrust washer can be arranged between the intermediate plate and the permanent magnet rotor. One bearing point can be arranged below the impeller and the other bearing point can be formed in the intermediate plate. Bearing contours for a thrust washer can be formed all around the bearing point in the intermediate plate. Said bearing contours allow the motor shaft to start the rotor smoothly with the support of the thrust washer.

In accordance with a preferred embodiment, a bearing is accommodated in the intermediate plate and the intermediate plate is sealed towards the pump head and the overmolding. The bearing can be inserted in the bearing receptacle or injected during production of the intermediate plate by means of injection molding. The intermediate plate has a radially larger diameter than the overmolding and is accurately fitted to the overmolding using a suitable method, such as laser welding. This ensures that the motor housing is materially bonded to the intermediate plate on one axial end face. Alternatively, a force-fitting or form-fitting connection can be provided for, the advantage being that no additional seals are required. In one alternative, the intermediate plate can be produced concurrently with the overmolding in one injection molding step, so that additional joining of the overmolding to the intermediate plate can be avoided. In a further embodiment, the intermediate plate can have an extended edge that encompasses the overmolding. The radial diameter of the intermediate plate is adapted to the overmolding. The region between the extended edge of the intermediate plate and the overmolding is sealed by means of a seal.

The invention is further based on the idea of providing a modular assembly for forming different fluid pumps with different power ratings as well as different electric drives with different power ratings with the electronically commutated motor, comprising a permanent magnet rotor supported on a motor shaft, a stator lamination stack, at least one insulating cap arranged on an axial end face of the stator lamination stack, a winding that runs across all coils of the stator lamination stack and is contacted by means of insulation-displacement contacts, wherein: the stator lamination stack, the at least one insulating cap and the winding form the stator and surround the permanent magnet rotor; the stator is completely surrounded on its outer region and at least partially on its inner region by an overmolding made of non-magnetic material, the overmolding forming a motor housing; at least one groove running parallel to the axis is formed in the inner region of the overmolding; at least two notches are formed on an axial end face of the overmolding, which are connected to one another via a radially circumferential channel; and a receiving space is formed in the motor housing, in which an electronics and a thermal plate are accommodated, wherein the motor housing is closed on an axial end face by a pump head with at least one hydraulic interface in order to form a fluid pump, in particular an oil pump, and wherein a holder is arranged in the pump head, wherein the holder receives a pump rotor, which is formed by an inner rotor and an outer rotor, and is pressed onto the motor shaft and supports the motor shaft in the holder.

The holder can be inserted into the pump head and screwed into the interior of the pump head. It is also conceivable to fasten the holder in or on the pump head using other fastening means or methods known to a person skilled in the art. The holder can be made of a metallic material or a thermosetting plastics material. A configuration made of thermosetting plastics material is advantageous in terms of the overall weight of the fluid pump in certain applications, as weight is saved. Another advantage is that no machining is usually necessary. It is also advantageous if the pump head is made of a thermoplastic material. Alternatively, the pump head can also be made of a metallic material.

In accordance with one development, the holder has a receptacle for the pump rotor and is configured as a fluid passage plate on an axial end face. The fluid passage plate has a receptacle for the motor shaft in the center. The fluid passage plate moreover has several fluid openings and several screw eyes in the edge region. Alternatively, the holder can also be formed in two parts; i.e., the fluid passage plate can be mounted on the holder as a finished part. The holder or the fluid passage plate can be made of a thermosetting plastics material and/or a metallic material.

In one embodiment, the holder in the fluid passage plate comprises or accommodates at least one bearing, preferably a plain bearing, which is configured as a monolithic bearing, and the at least one bearing has a pressure groove, which can be configured as a hydrodynamic groove. Alternatively, a plain bearing bushing instead of the plain bearing can be injected or mounted in the holder. The monolithic bearing creates an axially extended bearing receptacle in the holder so that the monolithic bearing extends all the way into the inner rotor. An axial bearing can be formed by an inner rotor pressed onto the motor shaft. The motor shaft can also be guided in an inner diameter of the holder. The inner diameter of the holder is therefore designed and tolerated such that it can describe or form a bearing. In addition, the inner diameter of the holder has a pressure groove, which can be configured as a hydrodynamic groove. The inner rotor is pressed onto the motor shaft in a rotationally fixed manner. The outer rotor is rotatably accommodated in the holder. The formed monolithic bearing in the holder is selected and constructed in terms of its axial length according to the modular performance classes such that it can extend all the way into the inner rotor.

The advantage is that the motor shaft is pressed into the inner rotor and supported in the bearing. This allows a simple, cost-effective motor shaft without additional shoulders to be used. A further advantage is that the inner rotor centers itself axially, which means that a bearing disk or other axial bearings are no longer required.

In a further embodiment, a fluid bypass is formed in the pump head from the at least one hydraulic interface towards an interior of the motor. The fluid flow leads through the fluid inlet via the fluid bypass to the interior of the motor, flushes a gap between the overmolding and the permanent magnet rotor, additionally leads through at least one fluid bore in the permanent magnet rotor, is pumped through the pump rotor and exits through a fluid outlet. This allows the fluid to circulate through the fluid pump and better dissipate the heat from the stator and the thermal plate, via which the electronics is cooled, into the fluid. This ensures excellent dissipation of heat from the heat-generating electronic components. Another advantage of the fluid bypass is that the pump chamber can be filled from two sides, which prevents cavitation at high fluid flow rates. Furthermore, no pressure due to leakage from the pump builds up inside the motor.

The invention is further based on the idea of providing a modular assembly for forming different fluid pumps with different power ratings as well as different electric drives with different power ratings with the electronically commutated, comprising a permanent magnet rotor supported on a motor shaft, a stator lamination stack, at least one insulating cap arranged on an axial end face of the stator lamination stack, a winding that runs across all coils of the stator lamination stack and is contacted by means of insulation-displacement contacts, wherein: the stator lamination stack, the at least one insulating cap and the winding form the stator and surround the permanent magnet rotor; the stator is completely surrounded on its outer region and at least partially on its inner region by an overmolding made of non-magnetic material, the overmolding forming a motor housing; at least one groove running parallel to the axis is formed in the inner region of the overmolding; at least two notches are formed on an axial end face of the overmolding, which are connected to one another via a radially circumferential channel; and a receiving space is formed in the motor housing, in which an electronics and a thermal plate are accommodated, wherein, in order to form an electric drive, the motor housing is closed on an axial end face by an end shield and wherein the motor shaft is supported in the end shield.

In an advantageous embodiment, the end shield and/or the thermal plate accommodates or comprises a bearing. The bearing in the end shield and/or in the thermal plate is preferably configured as a ball bearing. Alternatively, a double bearing can be accommodated or comprised only in the end shield.

In an alternative embodiment, the stator is partially overmolded on its outer region so that the stator lamination stack is partially free of non-magnetic material, the advantage being that the outer region of the stator lamination stack is not completely overmolded with non-magnetic material, which means that the heat from the stator is dissipated via the stator lamination stack into the ambient air or a housing. Not completely means that the stator lamination stack is partially free of non-magnetic material on its outer surface. Heat is dissipated from the motor via the end shield to the outside and into the ambient air and can also be dissipated via a metal ring that partially extends beyond the stator and that can be configured as part of the end shield. The end shield can advantageously be made of metallic material, which leads to a supporting dissipation of heat from the stator into the ambient air or the housing. However, an end shield made of a plastics material is also conceivable. Heat from the electronic components is additionally dissipated into the ambient air via the thermal plate, especially when the interior of the motor is flooded with air.

In accordance with one development, receiving contours are formed on the end shield, which serve for connecting various applications, such as a gearbox or other applications known to a person skilled in the art.

### BRIEF DESCRIPTION OF THE SEVERAL VIEWS OF THE DRAWINGS

The invention is explained in more detail on the basis of exemplary embodiments, with reference to the accompanying drawings, in which:

FIG. 1 shows a sectional view of the electronically commutated motor according to the invention according to a preferred embodiment;

FIG. 2 shows a dimensional plan view of the overmolding in accordance with FIG. 1;

FIG. 3 shows a dimensional view of the underside of the overmolding in accordance with FIG. 2;

FIG. 4 shows a dimensional plan view of the thermal plate in accordance with FIG. 1;

FIG. 5 shows a dimensional view of the underside of the thermal plate in accordance with FIG. 4;

FIG. 6 shows a sectional view of a modular assembly for forming a centrifugal pump in accordance with FIG. 1;

FIG. 7 shows a sectional view of a modular assembly for forming an oil pump in accordance with FIG. 1;

FIG. 8 shows a dimensional view of the holder in accordance with FIG. 7;

FIG. 9 shows a dimensional plan view of the holder in accordance with FIG. 8;

FIG. 10 shows a sectional view of a modular assembly for forming a drive in accordance with FIG. 1.

### DETAILED DESCRIPTION OF THE INVENTION

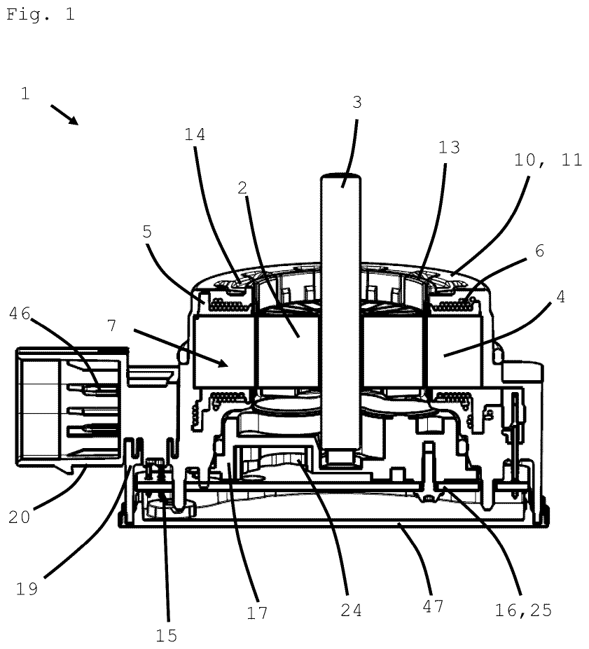

FIG. 1 shows a sectional view of the electronically commutated motor (1) according to the invention, comprising a permanent magnet rotor (2) supported on a motor shaft (3), a stator lamination stack (4); at least one insulating cap (5) arranged on an axial end face of the stator lamination stack (4); and a winding (6) running across all coils of the stator lamination stack (4) and contacted by means of insulation-displacement contacts. The stator lamination stack (4), the at least one insulating cap (5) and the winding (6) form the stator (7) and surround the permanent magnet rotor (2). The stator (7) is completely surrounded on its outer region (8) (not shown herein) and at least partially surrounded on its inner region (9) (not shown herein) by an overmolding (10) made of non-magnetic material. The overmolding (10) forms a motor housing (11). At least one groove (12) (not shown herein) running parallel to the axis is formed in the inner region (9) (not shown herein) of the overmolding (10) and at least two notches (13) are formed on an axial end face of the overmolding (10) which are connected to one another via a radially circumferential channel (14). A receiving space (15) is formed in the motor housing (11) in which an electronics (16) and a thermal plate (17) are accommodated. The electronics (16) comprises a populated PCB (25) responsible for controlling the motor. The PCB (25) can be populated with electronic components (24) on one or both sides. It is advantageous if the large electronic components (24) are arranged on the PCB (25) in the direction of the thermal plate (17) and protrude into the cutouts (23) (not shown herein) of the thermal plate (17). A receiving contour (19) for a connector (20) is formed on the outer region of the overmolding (10). The connector (20) comprises at least one connector tab (46) which is contacted with the PCB (25). The receiving space (15) of the motor housing (11) can be closed by an electronics cover (47).

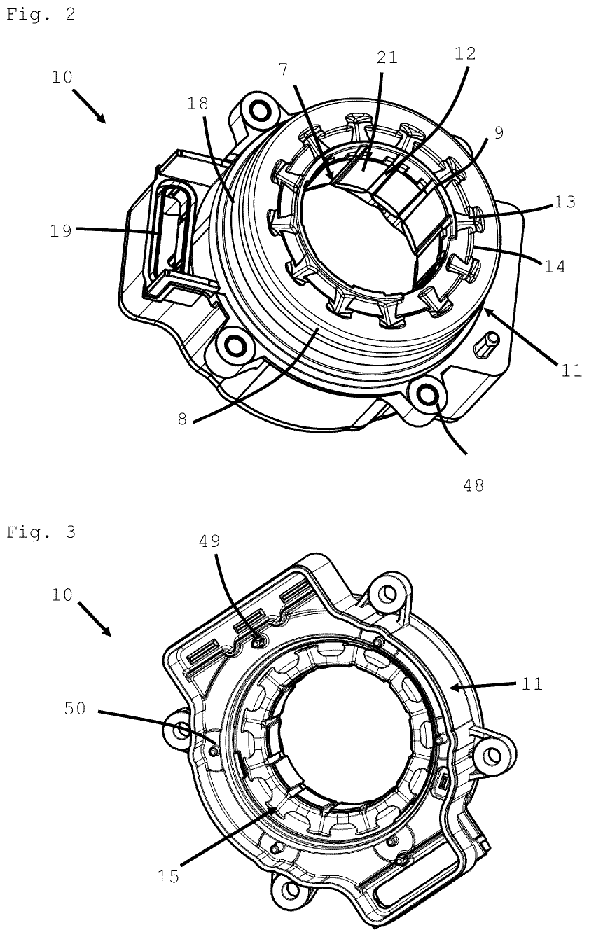

FIG. 2 shows a dimensional plan view of the overmolding (10) in accordance with FIG. 1. The stator (7) is completely surrounded on its outer region (8) and at least partially surrounded on its inner region (9) by an overmolding (10) made of non-magnetic material. The overmolding (10) forms a motor housing (11). At least one groove (12) running parallel to the axis is formed in the inner region (9) of the overmolding (10). At least two notches (13) are formed on an axial end face of the overmolding (10), which are connected to one another via a radially circumferential channel (14). Said notches (13) are located in the axial direction above the wound coils of the stator lamination stack (4) in the overmolding (10) and correspond to the at least one groove (12) in the inner region (9) of the overmolding (10) that runs parallel to the axis. The overmolding (10) has at least one radial groove (18) on the outer region (8) for receiving a sealing element and/or has a receiving contour (19) for a connector (20) (not shown herein). The overmolding (10) has recesses (21) in the inner region (9), preferably between the grooves (12) running parallel to the axis, such that the stator laminations of the stator lamination stack (4) (not shown herein) exposed within the recesses (21) are free of non-magnetic material. This allows the heat from the stator (7) to be dissipated directly into the liquid or into the ambient air. At least one screw eye (48) is formed on the outer region (8) of the overmolding (10) so that the motor housing (11) can be fastened to various applications.

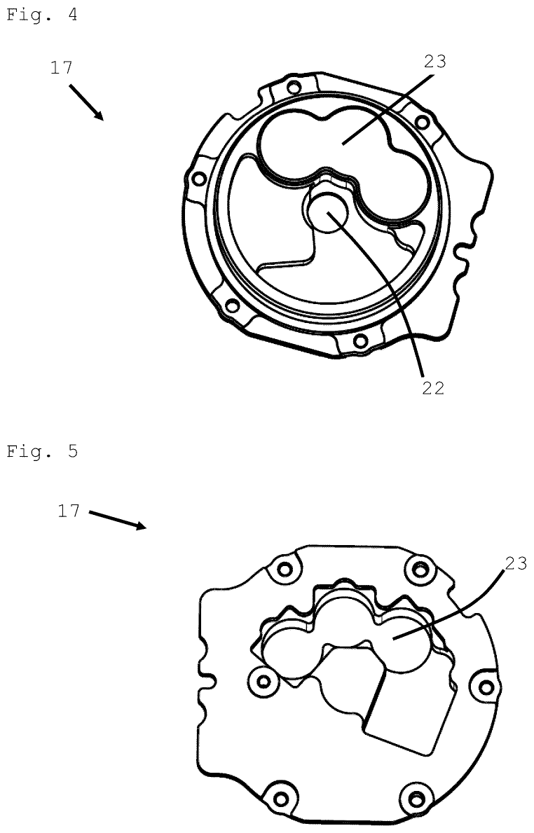

FIG. 3 shows a dimensional view of the underside of the overmolding (10) in accordance with FIG. 2. A receiving space (15) is formed in the motor housing (11) in which an electronics (16) (not shown herein) and a thermal plate (17) (not shown herein) are accommodated. At least one pin (49) is formed in the receiving space (15), on which the PCB (25) (not shown herein) is received. Moreover, at least one pin (50) is formed on which the thermal plate (17) is received.

FIG. 4 shows a dimensional plan view of the thermal plate (17) in accordance with FIG. 1. The thermal plate (17) has a bearing receptacle (22) on one side and several cutouts (23) on the other side for large electronic components (24) (not shown herein), which are arranged on a PCB (25) (not shown herein). A bearing can be accommodated in the bearing receptacle (22) in which the motor shaft (3) (not shown herein) is supported. Alternatively, the motor shaft (3) can also be accommodated in the bearing receptacle (22) without a bearing. The thermal plate (17) has at least one fastening hole on the radial outer surface, by means of which the thermal plate (17) is fastened to the overmolding (10) (not shown herein) with the at least one pin (50) (not shown herein), as well as several contours which are adapted to the receiving space (15) (not shown herein) of the motor housing (11) (not shown herein).

FIG. 5 shows a dimensional view of the underside of the thermal plate (17) in accordance with FIG. 4. The thermal plate (17) has several cutouts (23) on the side facing the electronics (16) (not shown herein), in which large electronic components (24) (not shown herein) are accommodated. Alternatively, the thermal plate (17) can also be configured as a flat plate without cutouts (23). In such case, the large electronic components (23) on the PCB (25) would point towards the electronics cover (47) (not shown herein).

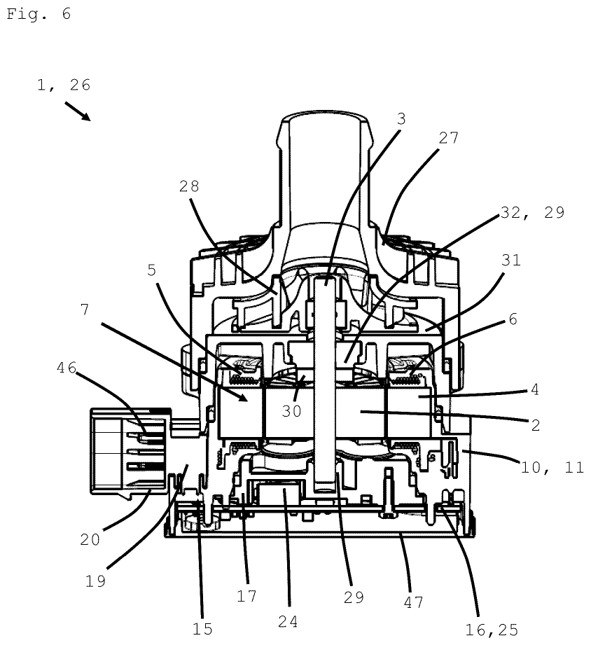

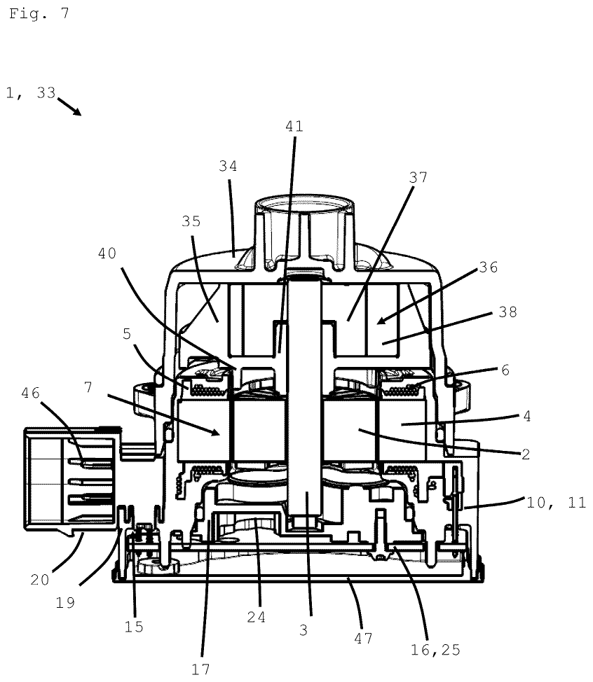

FIG. 6 shows a sectional view of a modular assembly for forming a centrifugal pump (26) in accordance with FIG. 1. The modular assembly is designed to form different fluid pumps with different power ratings as well as different electric drives with different power ratings with the electronically commutated motor (1). The electronically commutated motor (1) comprises a permanent magnet rotor (2) supported on a motor shaft (3), a stator lamination stack (4); at least one insulating cap (5) arranged on an axial end face of the stator lamination stack (4); and a winding (6) running across all coils of the stator lamination stack (4) and contacted by means of insulation-displacement contacts, wherein the stator lamination stack (4), the at least one insulating cap (5) and the winding (6) form the stator (7) and surround the permanent magnet rotor (2). The stator (7) is completely surrounded on its outer region (8) (not shown herein) and at least partially surrounded on its inner region (9) (not shown herein) by an overmolding (10) made of non-magnetic material. The overmolding (10) forms a motor housing (11). At least one groove (12) (not shown herein) running parallel to the axis is formed in the inner region (9) (not shown herein) of the overmolding (10) and at least two notches (13) (not shown herein) are formed on an axial end face of the overmolding (10) which are connected to one another via a radially circumferential channel (14) (not shown herein). A receiving space (15) is formed in the motor housing (11) in which an electronics (16) and a thermal plate (17) are accommodated. The electronics (16) comprises a populated PCB (25) responsible for controlling the motor. The PCB (25) can be populated with electronic components (24) on one or both sides. It is advantageous if the large electronic components (24) are arranged on the PCB (25) in the direction of the thermal plate (17) and protrude into the cutouts (23) (not shown herein) of the thermal plate (17). A receiving contour (19) for a connector (20) is formed on the outer region of the overmolding (10). The connector (20) comprises at least one connector tab (46) which is contacted with the PCB (25). The receiving space (15) of the motor housing (11) can be closed by an electronics cover (47).

The motor housing (11) is closed on an axial end face by an intermediate plate (31) and an impeller (28) is pressed onto the motor shaft (3) to form a fluid pump, in particular a centrifugal pump (26). A pump head (27) with a suction inlet and a pressure outlet is fastened to the intermediate plate (31). An impeller (28) is accommodated in the pump head (27) and is pressed onto the motor shaft (3). The motor shaft (3) is supported in two bearing points (29). A thrust washer (30) is arranged between the intermediate plate (31) and the permanent magnet rotor (2). A bearing (32) is accommodated in the intermediate plate (31) and the intermediate plate (31) is sealed towards the pump head (27) and the overmolding (10). The electronically commutated motor (1) can thus be used without modification as the main component of the modular assembly by components of the centrifugal pump (26) to form different centrifugal pumps (26) with different power ratings. This makes it possible to adapt the centrifugal pump (26) to different applications without major design changes.

FIG. 7 shows a sectional view of a modular assembly for forming an oil pump (33) in accordance with FIG. 1. The modular assembly is designed to form different fluid pumps with different power ratings as well as different electric drives with different power ratings with the electronically commutated motor (1). The electronically commutated motor (1) comprises a permanent magnet rotor (2) supported on a motor shaft (3), a stator lamination stack (4); at least one insulating cap (5) arranged on an axial end face of the stator lamination stack (4); and a winding (6) running across all coils of the stator lamination stack (4) and contacted by means of insulation-displacement contacts, wherein the stator lamination stack (4), the at least one insulating cap (5) and the winding (6) form the stator (7) and surround the permanent magnet rotor (2). The stator (7) is completely surrounded on its outer region (8) (not shown herein) and at least partially surrounded on its inner region (9) (not shown herein) by an overmolding (10) made of non-magnetic material. The overmolding (10) forms a motor housing (11). At least one groove (12) running parallel to the axis is formed in the inner region (9) (not shown herein) of the overmolding (10) and at least two notches (13) are formed on an axial end face of the overmolding (10) which are connected to one another via a radially circumferential channel (14) (not shown herein). A receiving space (15) is formed in the motor housing (11) in which an electronics (16) and a thermal plate (17) are accommodated. The electronics (16) comprises a populated PCB (25) responsible for controlling the motor. The PCB (25) can be populated with electronic components (24) on one or both sides. It is advantageous if the large electronic components (24) are arranged on the PCB (25) in the direction of the thermal plate (17) and protrude into the cutouts (23) (not shown herein) of the thermal plate (17). A receiving contour (19) for a connector (20) is formed on the outer region of the overmolding (10). The connector (20) comprises at least one connector tab (46) which is contacted with the PCB (25). The receiving space (15) of the motor housing (11) can be closed by an electronics cover (47). The thermal plate (17) can be configured as a single component or can be injection-molded to the overmolding (10) on one side.

The motor housing (11) is closed on an axial end face by a pump head (34) with at least one hydraulic interface to form a fluid pump, in particular an oil pump (33). A holder (35) is arranged in the pump head (34). The holder (35) accommodates a pump rotor (36) which is formed by an inner rotor (37) and an outer rotor (38). The pump rotor (36) is pressed onto the motor shaft (3) with its inner rotor (37). The motor shaft (3) is supported in the holder (35). The holder (35) has a receptacle (39) (not shown herein) for the pump rotor (36) and is configured as a fluid passage plate (40) on one axial end face. The holder (35) in the fluid passage plate (40) accommodates or comprises at least one bearing (41), preferably a plain bearing configured as a monolithic bearing. The at least one bearing (41) has a pressure groove (42) (not shown herein) which is configured as a hydrodynamic groove. A fluid bypass (43) is formed in the pump head (34) by the at least one hydraulic interface towards an interior of the motor. This allows the fluid (oil) to be directed specifically into the interior of the motor of the oil pump (33) and advantageously prevents oil turbulence. The electronically commutated motor (1) can thus be used without modification as the main component of the modular assembly by components of the oil pump (33) to form different oil pumps with different power ratings (33). This makes it possible to adapt the oil pump (33) to different applications without major design changes.

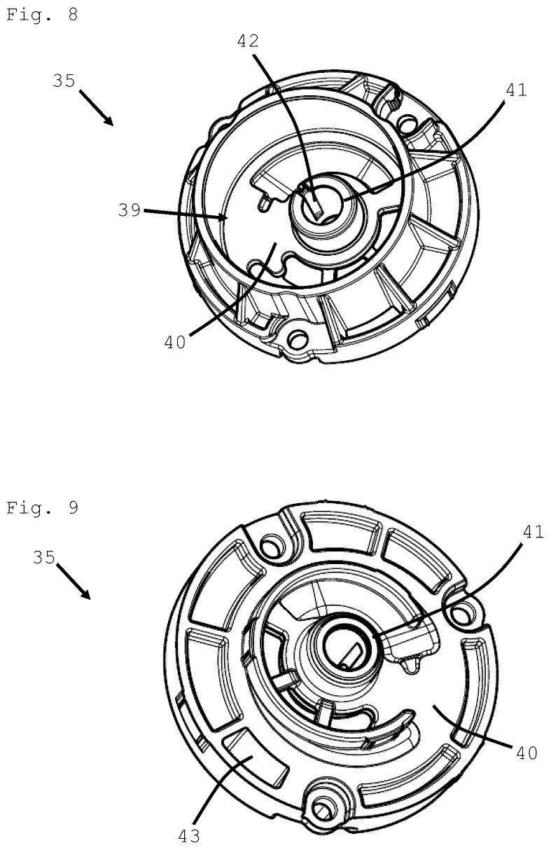

FIG. 8 shows a dimensional view of the holder (35) in accordance with FIG. 7. The holder (35) has a receptacle (39) for the pump rotor (36) and is configured as a fluid passage plate (40) on one axial end face. The holder (35) in the fluid passage plate (40) moreover accommodates or comprises at least one bearing (41), preferably a plain bearing configured as a monolithic bearing. The at least one bearing (41) has a pressure groove (42) which can be configured as a hydrodynamic groove. At least one screw eye is formed on the radial outer circumference of the holder (35), by means of which the holder (35) is screwed into the pump head after being pressed into the pump head (34) (not shown herein). Several fluid recesses are formed in the fluid passage plate (40) to ensure targeted fluid circulation into and out of the interior of the motor.

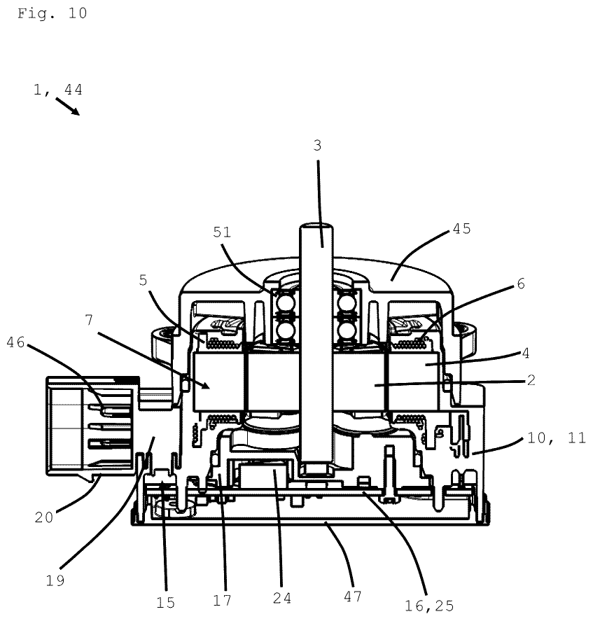

FIG. 9 shows a dimensional plan view of the holder (35) in accordance with FIG. 8. The holder (35) is formed on an axial end face as a fluid passage plate (40) which receives or forms at least one bearing (41). The bearing (41) here is preferably a plain bearing which is configured as a monolithic bearing. As a result, the bearing (41) is configured to be long enough to extend into the inner rotor (37) of the pump rotor (36) (not shown herein). A fluid bypass (43) in the pump head (34) is formed by a fluid opening in the fluid passage plate (40) from the at least one hydraulic interface towards an interior of the motor.

FIG. 10 shows a sectional view of a modular assembly for forming a drive in accordance with FIG. 1. The modular assembly is designed to form different fluid pumps with different power ratings as well as different electric drives with different power ratings with the electronically commutated motor (1). The electronically commutated motor (1) comprises a permanent magnet rotor (2) supported on a motor shaft (3), a stator lamination stack (4); at least one insulating cap (5) arranged on an axial end face of the stator lamination stack (4); and a winding (6) running across all coils of the stator lamination stack (4) and contacted by means of insulation-displacement contacts, wherein the stator lamination stack (4), the at least one insulating cap (5) and the winding (6) form the stator (7) and surround the permanent magnet rotor (2). A ball bearing (51) may be provided. The stator (7) is completely surrounded on its outer region (8) (not shown herein) and at least partially surrounded on its inner region (9) (not shown herein) by an overmolding (10) made of non-magnetic material. The overmolding (10) forms a motor housing (11). At least one groove (12) running parallel to the axis is formed in the inner region (9) (not shown herein) of the overmolding (10) and at least two notches (13) are formed on an axial end face of the overmolding (10) which are connected to one another via a radially circumferential channel (14). A receiving space (15) is formed in the motor housing (11) in which an electronics (16) and a thermal plate (17) are accommodated. The electronics (16) comprises a populated PCB (25) responsible for controlling the motor. The PCB (25) can be populated with electronic components (24) on one or both sides. It is advantageous if the large electronic components (24) are arranged on the PCB (25) in the direction of the thermal plate (17) and protrude into the cutouts (23) (not shown herein) of the thermal plate (17). A receiving contour (19) for a connector (20) is formed on the outer region of the overmolding (10). The connector (20) comprises at least one connector tab (46) which is contacted with the PCB (25). The receiving space (15) of the motor housing (11) can be closed by an electronics cover (47).

The motor housing (11) is closed on one axial end face by an end shield (45) to form an electric drive (44). The motor shaft (3) is supported in the end shield (45). The end shield (45) and/or the thermal plate (17) accommodates or comprises a bearing. The bearing in the end shield (44) and/or in the thermal plate (17) is preferably configured as a ball bearing (51). Alternatively, a double bearing can be accommodated or comprised only in the end shield (44). In an alternative embodiment, the stator (7) can be partially overmolded on its outer region (8) (not shown herein) so that the stator lamination stack (4) is partially free of non-magnetic material. At least one receiving contour is formed on the end shield (45), which serves as a connection for various applications, such as a gearbox. The electronically commutated motor (1) can thus be used without modification as the main component of the modular assembly by components of an electric drive (44) to form different drives with different power ratings (44). This makes it possible to adapt the drive (44) to different applications without major design changes.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE SYMBOLS

1. Motor
2. Permanent magnet rotor
3. Motor shaft
4. Stator lamination stack
5. Insulating cap
6. Winding
7. Stator
8. Outer region
9. Inner region
10. Overmolding
11. Motor housing
12. Groove running parallel to the axis
13. Notch
14. Channel
15. Receiving space
16. Electronics
17. Thermal plate
18. Radial groove
19. Receiving contour
20. Connector
21. Recesses
22. Bearing receptacle
23. Cutouts
24. Electronic components
25. PCB
26. Centrifugal pump
27. Pump head of centrifugal pump
28. Impeller
29. Bearing point
30. Thrust washer
31. Intermediate plate
32. Bearing
33. Oil pump
34. Pump head of oil pump
35. Holder
36. Pump rotor
37. Inner rotor
38. Outer rotor
39. Receptacle of holder
40. Fluid passage plate
41. Bearing
42. Pressure groove
43. Fluid bypass
44. Drive
45. End shield
46. Connector tab
47. Electronics cover
48. Screw eyes
49. PCB pin
50. Thermal plate pin
51. Ball bearing

What is claimed is:

1. An electronically commutated motor, comprising:
a permanent magnet rotor mounted on a motor shaft;
a stator lamination stack;
at least one insulating cap arranged on an axial end face of the stator lamination stack;
a winding that runs across all coils of the stator lamination stack and is contacted by means of insulation-displacement contacts,
wherein the stator lamination stack, the at least one insulating cap and the winding form the stator and surround the permanent magnet rotor;
the stator is completely surrounded on its outer region and at least partially on its inner region by an overmolding made of non-magnetic material, the overmolding forming a motor housing;
at least one groove running parallel to the axis is formed in the inner region of the overmolding;
at least two notches are formed on an axial end face of the overmolding, which are connected to one another via a radially circumferential channel; and
a receiving space is formed in the motor housing, in which an electronics and a thermal plate are accommodated.

2. The electronically commutated motor according to claim 1, wherein the overmolding has at least one radial groove on the outer region for receiving a sealing element or has a receiving contour for a connector.

3. The electronically commutated motor according to claim 1, wherein the thermal plate provides a bearing receptacle on one side and has several cutouts on the other side for large electronic components arranged on a printed circuit board (PCB).

4. A modular assembly for forming different fluid pumps with different power ratings as well as different electric drives with different power ratings with the electronically commutated motor according to claim 1, comprising a permanent magnet rotor mounted on a motor shaft, a stator lamination stack; at least one insulating cap arranged on an axial end face of the stator lamination stack, a winding that runs across all coils of the stator lamination stack and is contacted by means of insulation-displacement contacts, wherein: the stator lamination stack, the at least one insulating cap and the winding form the stator and surround the permanent magnet rotor; the stator is completely surrounded on its outer region and at least partially on its inner region by an overmolding made of non-magnetic material, the overmolding forming a motor housing; at least one groove running parallel to the axis is formed in the inner region of the overmolding; at least two notches are formed on an axial end face of the overmolding, which are connected to one another via a radially circumferential channel; and a receiving space is formed in the motor housing, in which an electronics and a thermal plate are accommodated, wherein the motor housing is closed on an axial end face by an intermediate plate to form a fluid pump, in particular a centrifugal pump, and wherein an impeller is pressed onto the motor shaft.

5. The modular assembly according to claim 4, wherein a pump head with a suction inlet and a pressure outlet is fastened to the intermediate plate.

6. The modular assembly according to claim 4, wherein the motor shaft is mounted in two bearing points and wherein a thrust washer is arranged between the intermediate plate and the permanent magnet rotor.

7. The modular assembly according to claim 4, wherein a bearing is accommodated in the intermediate plate and the intermediate plate is sealed towards the pump head and the overmolding.

8. A modular assembly for forming different fluid pumps with different power ratings as well as different electric drives with different power ratings with the electronically commutated motor according to claim 1, comprising a permanent magnet rotor mounted on a motor shaft, a stator lamination stack; at least one insulating cap arranged on an axial end face of the stator lamination stack, a winding that runs across all coils of the stator lamination stack and is contacted by means of insulation-displacement contacts, wherein: the stator lamination stack, the at least one insulating cap and the winding form the stator and surround the permanent magnet rotor; the stator is completely surrounded on its outer region and at least partially on its inner region by an overmolding made of non-magnetic material, the overmolding forming a motor housing; at least one groove running parallel to the axis is formed in the inner region of the overmolding; at least two notches are formed on an axial end face of the overmolding, which are connected to one another via a radially circumferential channel; and a receiving space is formed in the motor housing, in which an electronics and a thermal plate are accommodated, wherein the motor housing is closed on an axial end face by a pump head with at least one hydraulic interface in order to form a fluid pump, in particular an oil pump, and wherein a holder is arranged in the pump head, wherein the holder receives a pump rotor, which is formed by an inner rotor and an outer rotor, and is pressed onto the motor shaft and mounts the motor shaft in the holder.

9. The modular assembly according to claim 8, wherein the holder has a receptacle for the pump rotor and is configured as a fluid passage plate on one axial end face.

10. The modular assembly according to claim 8, wherein the holder in the fluid passage plate accommodates or comprises at least one bearing, preferably a plain bearing, which is configured as a monolithic bearing, and the at least one bearing has a pressure groove, which can be configured as a hydrodynamic groove.

11. The modular assembly according to claim 8, wherein a fluid bypass is formed in the pump head from the at least one hydraulic interface towards an interior of the motor.

12. A modular assembly for forming different fluid pumps with different power ratings as well as different electric drives with different power ratings with the electronically commutated motor according to claim 1, comprising a permanent magnet rotor mounted on a motor shaft, a stator lamination stack; at least one insulating cap arranged on an axial end face of the stator lamination stack, a winding that runs across all coils of the stator lamination stack and is contacted by means of insulation-displacement contacts, wherein: the stator lamination stack, the at least one insulating cap and the winding form the stator and surround the permanent magnet rotor; the stator is completely surrounded on its outer region and at least partially on its inner region by an overmolding made of non-magnetic material, the overmolding forming a motor housing; at least one groove running parallel to the axis is formed in the inner region of the overmolding; at least two notches are formed on an axial end face of the overmolding, which are connected to one another via a radially circumferential channel; and a receiving space is formed in the motor housing, in which an electronics and a thermal plate are accommodated, wherein the motor housing is closed on an axial end face by an end shield to form an electric drive and wherein the motor shaft is mounted in the end shield.

13. The modular assembly according to claim 12, wherein the end shield or the thermal plate accommodates or comprises a bearing.

14. The modular assembly according to claim 12, wherein the stator is partially overmolded on its outer region so that the stator lamination stack is partially free of non-magnetic material.

15. The modular assembly according to claim 12, wherein at least one receiving contour is formed on the end shield, which serves as a connection for various applications.
